(19) United States
(12) Patent Application Publication
(10) Pub. No.: US 2008/0079997 A1
(43) Pub. Date: Apr. 3, 2008

(54) PRINT PROCESSING APPARATUS

(76) Inventor: Shinichi KAWANO, Nara (JP)

Correspondence Address: BIRCH STEWART KOLASCH & BIRCH, PO BOX 747, FALLS CHURCH, VA, 22040-0747, US

(21) Appl. No.: 11/865,609

(22) Filed: Oct. 1, 2007

(30) Foreign Application Priority Data
Oct. 2, 2006 (JP) 2006-270647

(51) Int. Cl. G06K 15/00

(52) U.S. Cl. 358/1.15

(57) ABSTRACT

A print processing apparatus for sending image data to a printer having a sheet storage section for storing a sheet and a printing section for printing on the sheet the image data received from an outside apparatus, the print processing apparatus including: a setting section of print copies for allowing a user to set the number of the print copies; a deriving section for deriving a size of the sheet to contain at least one page of the image data, the number of pages to be contained in the sheet, and the number of sheets required for printing, based on a size of the sheet stored in the sheet storage section, on a size of each page of the image data, and on the set number of the print copies; a display section for displaying derived results as a candidate of a print condition; and a determination section for allowing the user to determine the displayed candidate.

### CROSS-REFERENCE TO RELATED APPLICATION

This application is related to Japanese application No. 2006-270647 filed on Oct. 2, 2006 whose priority is claimed under 35 USC §119, the disclosure of which is incorporated by reference in its entirety.

### BACKGROUND OF THE INVENTION

1. Field of the Invention

The present invention relates to a print processing apparatus for supplying a printer with image data for printing a plurality of images together on a sheet of one page.

2. Description of the Related Art

There is known a printer for printing a plurality of images together on a sheet of one page when images to be printed are smaller than a size of a print sheet and a print processing apparatus for giving instructions to the printer. Also, there is known a printer for dividing and printing one image when the image to be printed is larger than the size of the print sheet. Thus, the image to be printed and the page of the print sheet are not necessarily correspondent one-to-one in some cases. It is desired to provide a printer whereby, when the image and the page of the print sheet are not correspondent one-to-one, a user performs a printing operation easily and can recognize a print result correctly.

For example, there is known one in which, when the image larger than the print sheet is divisionally printed, a screen in a lattice shape showing a divided position of a printed-out image is printed and a black point is automatically added, so that the user can easily recognize a precise position of a divided image (for example, see Japanese Unexamined Patent Publication No. 7-288757).

Particularly, image printing with a printer has been increasing in recent years due to presence of a printer of improved image quality, coloration, and of increased processing speed. There are an increased number of images printed in relatively smaller sizes compared to a general print sheet of A4 size, particularly such as an image photographed by a camera mounted to a cellular phone.

A print size of such an image is usually significantly smaller than a fixed size such as A4, A3, B5, B4, or a letter size which has been frequently used in a business machine. In addition, the user is unfamiliar with actual dimensions of such a print size. Accordingly, for example, when a variable magnification is performed according to the size of the print sheet, the user tends not to be sure what operation should be performed to set an appropriate magnification ratio. Due to repeated processes of trial and error by the user, there is a possibility that a useless printing is performed. In a case of only a size publicly known as a size for photograph printing such as an L-type or a DSC size, a proper magnification ratio may be prepared as a preset value. However, the print size corresponding to the number of pixels of the image is not always limited to the L-type or DSC size. There is desired a printer in which easy use of the print sizes of so-called unfixed sizes.

### SUMMARY OF THE INVENTION

The present invention is provided in view of the above-described circumstances, and an object of the present invention is to provide a method of allowing a user to easily grasp a printable sheet size and a mode of print when an image of a size smaller than a print sheet is to be printed.

The present invention provides a print processing apparatus for sending image data to a printer having a sheet storage section for storing a sheet and a printing section for printing on the sheet the image data received from an outside apparatus, the print processing apparatus including: a setting section of print copies for allowing a user to set the number of the print copies; a deriving section for deriving a size of the sheet to contain at least one page of the image data, the number of pages to be contained in the sheet, and the number of sheets required for printing, based on a size of the sheet stored in the sheet storage section, on a size of each page of the image data, and on the set number of the print copies; a display section for displaying derived results as a candidate of a print condition; and a determination section for allowing the user to determine the displayed candidate.

With the printer of the present invention which includes the deriving section for deriving a size of the sheet to contain at least one page of the image data, the number of pages to be contained in the sheet, and the number of sheets required for printing, based on a size of the sheet stored in the sheet storage section, on a size of each page of the image data, and on the set number of the print copies and the display section for displaying derived results as a candidate of a print condition, a user can easily recognize a size of a printable sheet, the number of images to be contained in the sheet, and the number of sheets required for printing. Therefore, for example, when printing is performed by designating a hand feed tray as a sheet storage section, the user can start printing after setting the number of sheets required for printing on the hand feed tray.

### BRIEF DESCRIPTION OF THE DRAWINGS

FIG. 1 is an explanatory view showing a mode of a print processing apparatus and a printer according to the present invention;

FIG. 2A and 2B are block diagrams showing outlines of internal structures of a digital composite machine 1 and a personal computer 5 of FIG. 1;

FIG. 3 is an explanatory view showing an example of a screen displaying information on a candidate derived by a deriving section in the print processing apparatus of the present invention (Embodiment 1);

FIG. 4 is an explanatory view showing an example of a screen displaying information on respective candidates, when a plurality of candidates are derived by the deriving section in the print processing apparatus of the present invention (Embodiment 2);

FIG. 5 is an explanatory view showing an example of displaying on the screen only a predetermined number of the candidates when a plurality of candidates are derived by the deriving section in the print processing apparatus of the present invention (Embodiment 2);

FIG. 6 is an explanatory view showing an example of a screen displaying a thumbnail of the selected candidate in the print processing apparatus of the present invention (Embodiment 3);

FIG. 7 is an explanatory view showing another example of the screen displaying the thumbnail of the selected candidate in the print processing apparatus of the present invention (Embodiment 3);

FIG. 8 is an explanatory view showing an example of a screen displaying a decided candidate by referencing history information in the print processing apparatus of the present invention (Embodiment 2);

FIG. 9 is an explanatory view showing an example of a screen for inputting whether or not to print with a boundary line drawn around the image to be printed in the print processing apparatus of the present invention;

FIG. 10 is an explanatory view showing an example of a screen for image positional adjustment in the print processing apparatus of the present invention (Embodiment 4);

FIG. 11 is an explanatory view showing an example of a magnification ratio setting screen for individually adjusting the magnification ratio of each of the images to be printed on a sheet, in the print processing apparatus of the present invention (Embodiment 5);

FIG. 12 is an explanatory view showing an example of a screen for allowing a user to adjust the number of images per one page of the sheet, in the print processing apparatus of the present invention (Embodiment 5);

FIG. 13 is a flowchart showing an example of print processing executed by the print processing apparatus of the present invention (Embodiment 1);

FIG. 14 is a flowchart showing another example of print processing executed by the print processing apparatus of the present invention (Embodiment 2);

FIG. 15 is a flowchart showing still another example of print processing executed by the print processing apparatus of the present invention (Embodiment 4); and

FIG. 16 is a flowchart showing details of processing of moving a display position of a thumbnail and a print position of the image according to an operation of the screen, in Step S41 of FIG. 15 (Embodiment 4).

### DETAILED DESCRIPTION OF THE PREFERRED EMBODIMENTS

According to the print processing apparatus of the present invention, when there are a plurality of candidates, the display section may display the candidates entirely or partially, and the determination section allows the user to select one of the candidates. According to this structure, the user can select a desired sheet from a plurality of candidates. The user can easily recognize the sheet suitable for printing based on displayed candidate information.

Further, the print processing apparatus may further include: a display control section for controlling to display each of the candidates selectable by using a scroll bar when the display section has a width for displaying only a part of the candidates. According to this structure, even when a display area is narrow, the user can visually recognize all candidates by using a scroll bar. Therefore, even when there are too many candidates to be displayed at once, the user can easily confirm all the candidates and designate a desired candidate.

The print processing apparatus may further include: a thumbnail generation section for generating a thumbnail of an image included in the image data; and a display control section for controlling to display thumbnails according to the number of images to be contained in the sheet. According to this structure, the user can start printing after visually recognizing what image is to be printed on the sheet prior to printing. A thumbnail of the image to be printed may be displayed when the user temporarily decides the candidate, so that the user finally decides the candidate after confirming the display.

Further, a plurality of images may be contained in the sheet, the deriving section may further derive an arrangement of each of the images, and the display control section may display the thumbnails according to the number of the images to be contained in the sheet and the arrangement thereof. According to this structure, the user can start printing after visually recognizing what images arc to be printed prior to printing. A thumbnail according to an arrangement of the images to be printed may be displayed when the user temporarily decides the candidates, so that the user finally decides the candidates after confirming the display.

Further, the print processing apparatus may further include: a history storage section for storing a determined print condition as a history; and a display control section for determining the candidate to be displayed according to the history. According to this structure, since the candidate to be displayed is decided based on history information, the candidate with high possibility of being decided is displayed. Therefore, the user can easily select the candidate.

Alternately, when a plurality of images are contained in the sheet, the printing section may print each of the images with boundary lines. According to this structure, when the user divides a printed image, a notch can be printed. The image divided along a dividing line can be easily handled because each size is aligned.

The print processing apparatus may further include: a thumbnail movement control section for controlling the displayed thumbnails to be moved by the user on the display section; and a print position control section for controlling a print position so that each of the images is printed at the position on the sheet corresponding to a display position of each of the thumbnails. According to this structure, the user can be provided with a unit for adjusting a print position while visually recognizing a print result, which is convenient for the user. For example, adjustment of concentrating the image in a central part of the sheet or expanding the image close to a periphery of the sheet can be surely performed according to an intention of the user.

In addition, the print processing apparatus may further include: a thumbnail size control section for controlling sizes of the displayed thumbnails to be expanded and reduced by the user on the display section; and a control section of a print magnification ratio for controlling the print magnification ratio so that each of the images is printed on the sheet with the print magnification ratio corresponding to the sizes of the displayed thumbnails. According to this structure, the user can be provided with a unit for expanding or reducing an individual image while visually recognizing the print result, which is convenient for the user. In addition, the user can easily set a print mode in which the desired number of images can be printed on one page.

Further, the print processing apparatus may further include: an instruction section of the number of images for controlling the number of the images contained in the sheet to be changed by the user. According to this structure, the user can be provided with a unit for adjusting the number of images to be contained in the sheet based on a user's intention. In other words, the user can adjust an interval between respective images to be contained in the sheet according to the intention of the user.

The present invention will be further described with reference to the drawings. Description to be given below will be helpful for better understanding of this invention. Note that the description given below is exemplification in all points and is not restrictive.

### (Structures of a Print Processing Apparatus and a Printer)

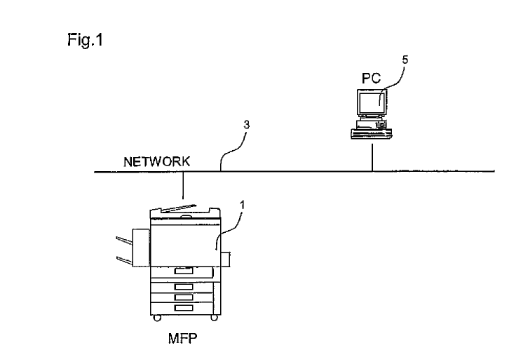

FIG. 1 is an explanatory view showing one mode of the print processing apparatus and the printer according to the present invention. In FIG. 1, a specific mode of the printer is a digital composite apparatus (MFP, namely, a Multi Function Peripheral) 1. The digital composite apparatus 1 of FIG. 1 is connected to a PC (Personal Computer) 5 serving as a host via a network 3. The personal computer 5 is one mode of the print processing apparatus, and transmits print data, namely, so-called image data in claims, to the digital composite apparatus 1 via the network 3.

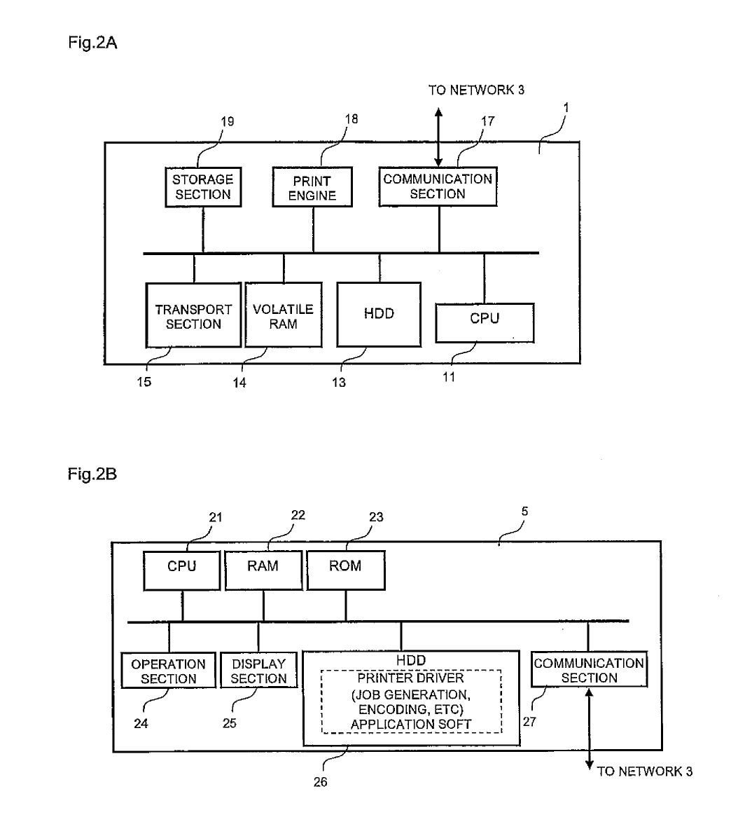

FIG. 2A and 2B are block diagrams showing outlines of internal structures of the digital composite apparatus 1 and the personal computer 5. As shown in FIG. 2A, the digital composite apparatus 1 includes each block of a CPU 11, an HDD 13, a volatile RAM 14, a transport section 15, a communication section 17, a print engine 18, and a storage section 19. The communication section 17 is a block for performing communication with external equipment connected via the network 3, such as the personal computer 5. The communication section 17 functions as a so-called reception section in claims. The CPU 11 controls an operation of each section of the digital composite apparatus 1, and controls a series of processing of print data such as developing processing of the print data received from the host until supplying it to the print engine 18. The HDD 13 is a hard disk apparatus storing the print data received from the host and data developed from the print data in a form capable of being printed by the print engine 18. The volatile RAM 14 is, for example, an SDRAM, and provides a work area of the CPU 11, and functions as a buffer in which the print data is temporarily accumulated. The storage section 19 is a section storing a sheet for print and is a so-called sheet storage section in claims. The transport section 15 transports the sheet fed from the storage section 19 to the outside a machine through the print engine 18. The print engine 18 is a so-called printing section in claims, forms an image according to the received print data, and transfers the formed image on the sheet.

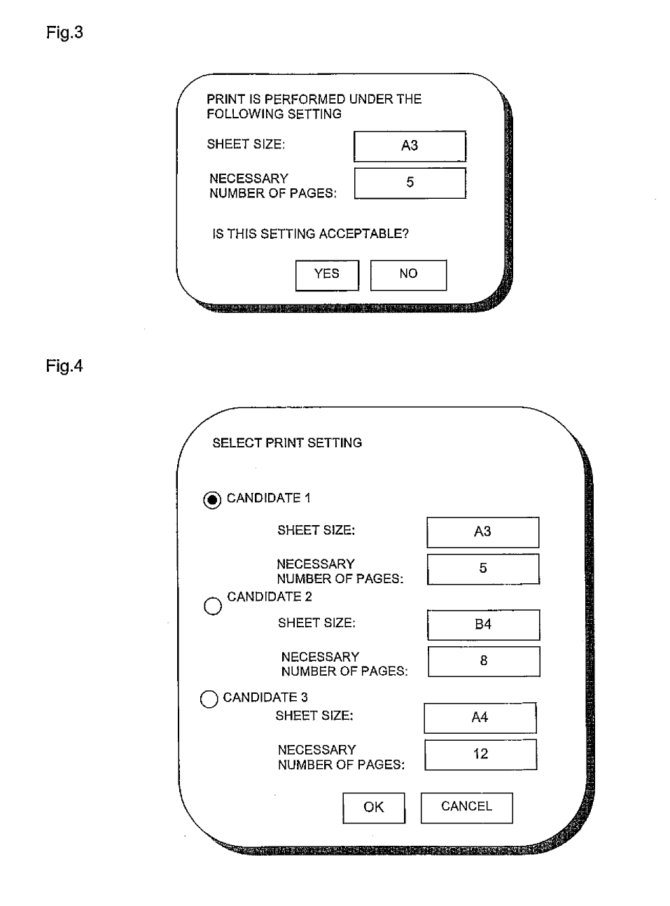

Further, as shown in FIG. 2B, the personal computer 5 has a CPU 21, a RAM 22, an ROM 23, an operation section 24, a display section 25, an HDD 26, and a communication section 27. The CPU 21 executes a printer driver program stored in the HDD 26, and realizes functions as a so-called deriving section, a display control section, a thumbnail movement control section, a print position control section, a thumbnail size control section, and a control section of a print magnification ratio, respectively in claims, and generates the print data according to an determined condition. The RAM 22 provides the work area of the CPU 21. In addition, when the program stored in the HDD is executed by the CPU 21, the RAM 22 provides an area where the program is downloaded. The ROM 23 stores BIOS of the personal computer 5. The operation section 24 functions to given an instruction by a user to the processing executed by the personal computer 5, and a keyboard or mouse is given as an example of a specific mode. Further, by operating the operation section 24 by the user while observing a screen displayed on the display section 25, functions of so-called setting section of print copies and a determination section in claims are realized. The display section 25 displays information to the user by the personal computer 5, and an example of a specific mode is a liquid crystal display. Each screen sown in FIG. 3 to FIG. 12 is displayed on the display section 25. The HDD 26 stores the program executed by the CPU 21 such as a printer driver program, and stores the data processed by the CPU 21 such as image data. The function of a so-called history storage section in claims is realized by the processing by the HDD 26 and the CPU 21. The communication section 27 is a block performing communication with the external equipment connected via the network 3, such as the digital composite apparatus 1.

### Embodiment 1

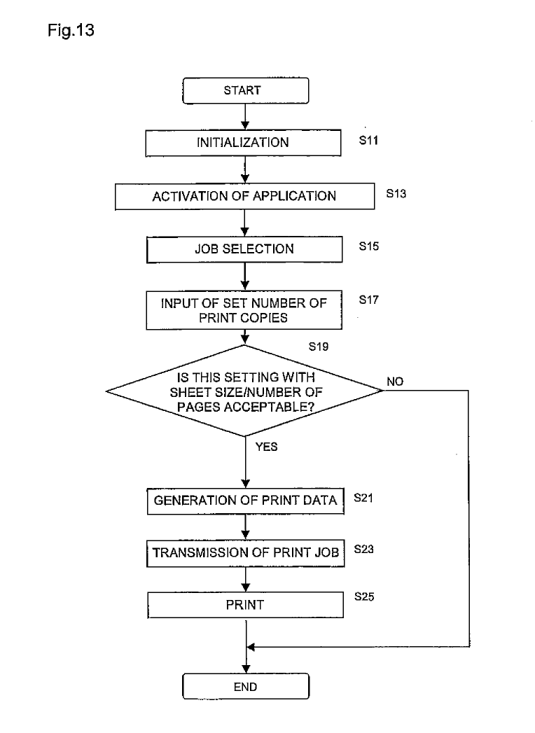

In this embodiment, description is given to a characteristic function of the print processing apparatus of the present invention. FIG. 13 is a flowchart showing an example of processing executed by the CPU 21 serving as the print processing apparatus of the present invention. In FIG. 13, when power is supplied to the personal computer 5, the CPU 21 first executes initialization processing to initialize hardware of the apparatus, activates an OS to start execution of a driver soft such as a printer driver, secures a variable area to be used in the processing as the print processing apparatus, and initializes values of the variables (Step S11). After such an initialization processing, the CPU 21 starts the execution of application software according to the operation by the user (Step S13). When the user requests print processing of the data in an application in execution (Step S15), the CPU 21 executes a processing content of the printer driver program to execute the function of the print processing apparatus. The CPU 21 displays a print setting screen on the display section 25 first, so that the user can perform setting of a print job, before executing the print processing. By using a setting screen thus displayed, the user can set each kind of print condition according to an intended print job (Step S17). As the print job set by the user, for example, designation of the printer as an output destination, and setting of the image quality and a print function are included. The setting condition related to this invention includes the setting of the number of print copies. In addition, as one of the setting conditions, a mode of printing a plurality of images of small print sizes on one page may be permitted or inhibited according to the intention of the user. In this case, the mode is permitted in this embodiment.

When each setting condition is set and print start is instructed by the user, under a control of the CPU 21 according to an instruction, the information on the candidate of a printable sheet is displayed on the display section 25, and whether or not print is performed under a derived setting is confirmed (Step S19). FIG. 3 is an explanatory view showing an example of the screen on which the information on the candidate derived by the deriving section is displayed. The information displayed on the screen of FIG. 3 is derived by the deriving section based on the information on the sheet storage section acquired by the printer driver from the printer and the number of print copies set by the user. The size of a printable sheet out of the sheets stored in a designated printer is A3 size. When there is other candidate, this case will be described later. The screen of FIG. 3 shows that five images are printed on one page of the sheet. A button of “Yes” or “No” is displayed in the screen of FIG. 3, and the print processing is not started until either of these buttons is selected by the user. Here, when the user selects the button of “NO”, the print processing is canceled. When the user selects the button of “Yes”, the displayed candidate is determined as the sheet for print. Namely, the “Yes” button functions as a so-called determination section in claims. When the “Yes” button is pressed, the CPU 21 generates the print data under a determined condition (Step S21), and transmits the generated print data to the digital composite apparatus 1 as the print job (Step S23). The contents of the transmitted print job include the generated print data, the size of the sheet for print, and other set condition, etc. When the print data is received from the personal computer 5, the digital composite apparatus 1 executes printing following the contents of the print job.

### Embodiment 2

In Embodiment 1, only one candidate is derived. In this embodiment, description is given to the processing of a case of deriving a plurality of candidates. When the plurality of candidates are derived, under the control of the CPU 21, each candidate is displayed and one of them is selected by the user. FIG. 4 is an explanatory view showing an example of the screen displaying the information on each candidate, when three candidates are derived by the deriving section. The screen of FIG. 4 may be displayed instead of the screen of FIG. 3 in Embodiment 1. Alternately, a candidate 1 (A3 size) is preferentially displayed (the screen of FIG. 3) first, and when the user selects the “No” button in the screen of FIG. 3, the screen of FIG. 4 including other candidate may be displayed next. In FIG. 4, three candidates of A3 size, B4 size, and A4 size are displayed as the candidates of the printable sheet. It is found from a displayed content, that the sheet of five pages for A3 size, six pages for B4 size, and nine pages for A4 size are required for executing the print job. In order to select one from the three candidates, a radio button is provided corresponding to each candidate. FIG. 4 shows a state of selecting the candidate 1 by the user. In this sate, when the user selects an “OK” button, the setting condition of the candidate 1 is determined and the print is started.

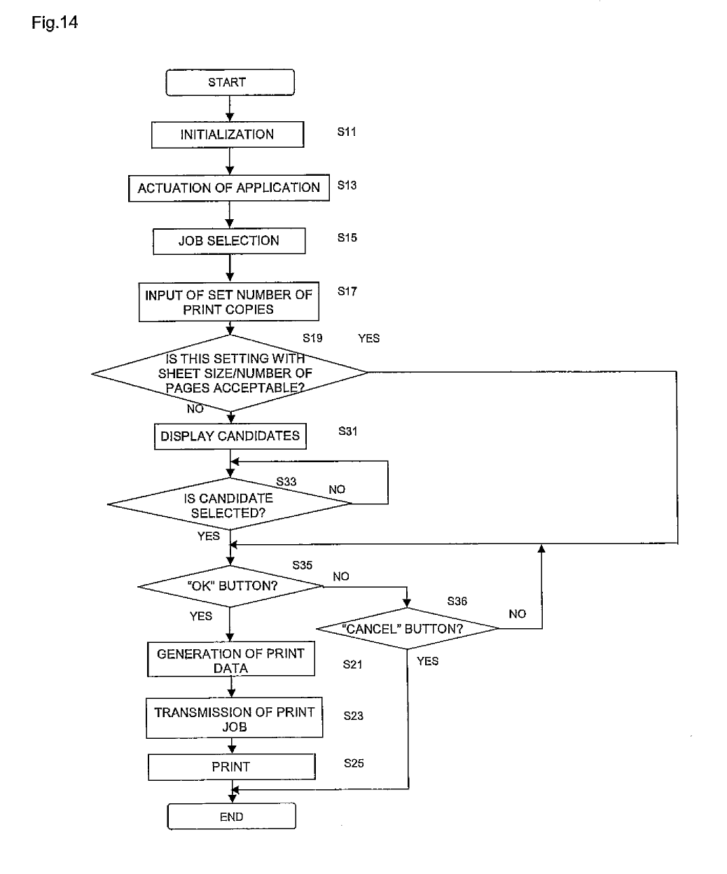

FIG. 14 is a flowchart corresponding to this embodiment. The same signs and numerals are assigned to the step corresponding to FIG. 13. Steps S31, S33, S35 and S36 are different points from FIG. 13. In Step S19, the screen of FIG. 3 is displayed. When the user selects the “No” button in the screen of FIG. 3, the CPU 21 displays the screen of FIG. 4 including other candidates (Step S31). When the user selects one candidate in the screen of FIG. 4 (Step S33) and selects the “OK” button (Step S35), the print condition is determined. The CPU 21 starts generating the print data under the determined condition (Step S21). Meanwhile, when the user selects a “Cancel” button in the screen of FIG. 4 (Step S36), the print processing is canceled.

When there are a plurality of candidates and all of them cannot be displayed simultaneously, or when the plurality of candidates are limited to a prescribed number to be displayed, only a part of the candidates may be displayed while the other candidates are to be displayed by operating a scroll bar. FIG. 5 is an explanatory view showing an example of the screen in which the candidates are narrowed to two candidates and displayed, when two or more candidates are derived by the deriving section. Other candidates can be displayed by operating the scroll bar.

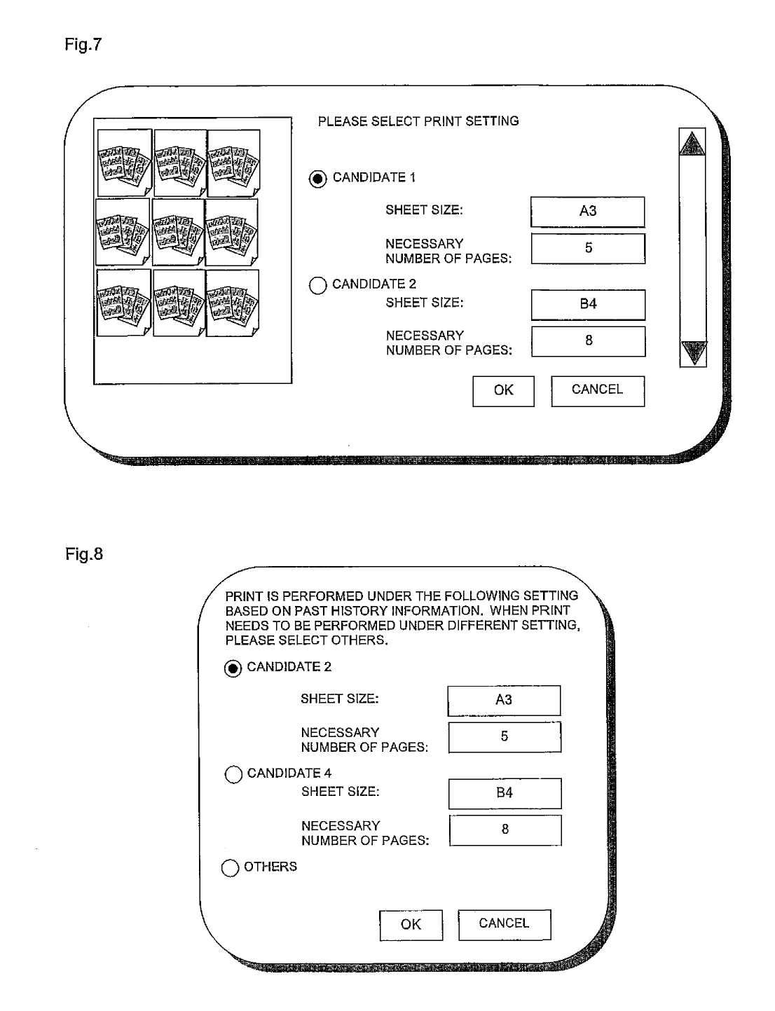

As a modified example, a history of the candidate selected in the past is stored as history information, and when the candidate displayed in the screen is decided, the deriving section references the stored history and the candidate with high number of times of being selected may be preferentially displayed. For example, the number of candidates displayed in the screen is defined as two in advance. The deriving section references the history, and extracts two from the candidates with high number of times of being selected, out of the derived candidates. FIG. 8 is an explanatory view showing an example of the screen displaying the decided candidate by referencing the history. Now, if the deriving section derives four candidates (candidate 1 to candidate 4), the deriving section references the history information and decides two candidates with high number of times of being selected in the past, out of the four candidates. If a candidate 2 (A3 size) has the greatest number of times of being selected and a candidate 4 (B4 size) has the next greatest number of times of being selected, two candidates such as candidate 2 and candidate 4 are displayed by the deriving section, based on a reference result of the history information. FIG. 8 shows this screen. In the screen of FIG. 8, when the user selects the candidate 2 and selects the “OK” button, the size of the sheet for print is determined as A3, and the print is performed under the determined condition. Alternately, when the user selects “others”, under the control of the CPU 21, a display screen is switched and derived candidates 1 to 4 are displayed. Alternately, when the candidates 1 to 4 cannot be displayed, under the control of the CPU 21, the screen, in which each candidate can be displayed, is displayed by scroll operation.

### Embodiment 3

In this embodiment, description is given to a mode of displaying a content to be printed as a thumbnail prior to printing. Generation of the thumbnail itself for the image data has been performed conventionally. However, in this invention, by displaying the thumbnail before staring printing, the user can significantly easily grasp how many images are printed on one page. By visually confirming a finish before printing, failure in printing is prevented from occurring, and waste of sheets, toner, and operation time can be eliminated.

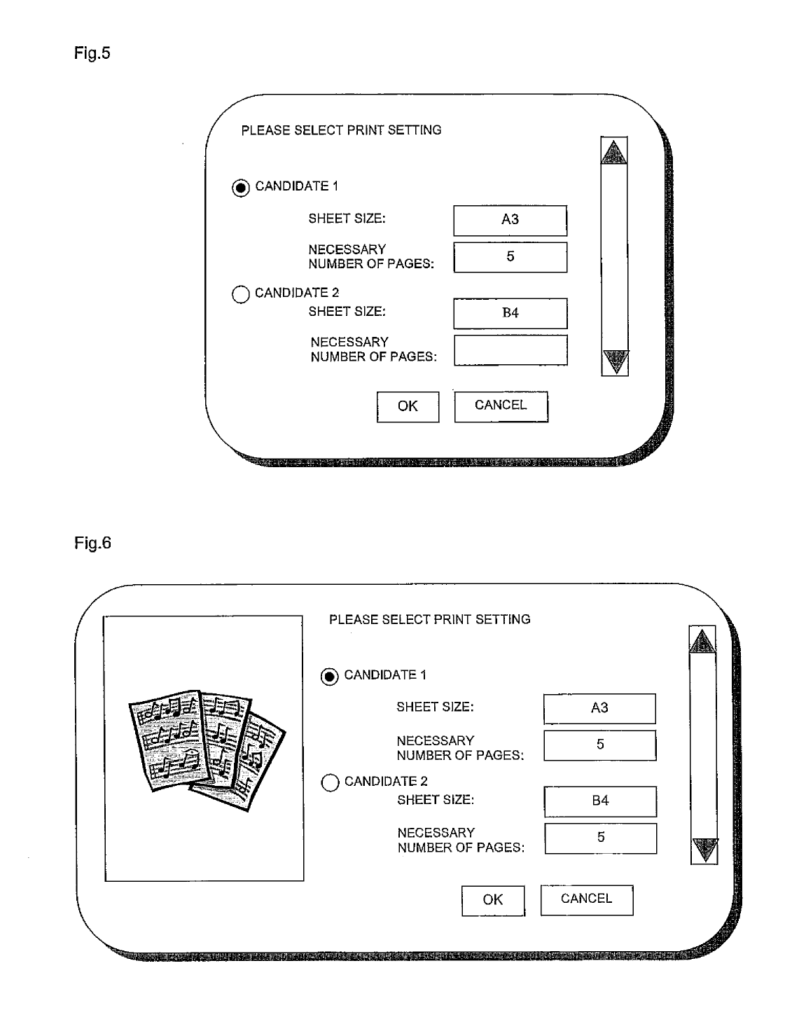

FIG. 6 is an explanatory view showing an example of a screen displaying the thumbnail of the selected candidate in addition to the information on the candidate derived by the deriving section. FIG. 6 shows the screen to replace the screen of FIG. 4 in Embodiment 2. FIG. 6 shows a case of the candidate 1 wherein one image is printed on one page. Here, when the user selects the candidate 2, the display is updated to a thumbnail display according to the candidate 2. However, in a case of FIG. 6, a sheet size of the candidate 2 is smaller than that of the candidate 1. Even if the candidate 2 is selected, the number of images on one page is still one.

FIG. 7 is an explanatory view showing another example of a screen displaying the thumbnail of the selected candidate in addition to the information on the candidate derived by the deriving section. In FIG. 7, in a case of the candidate 1 (A3 size), 3×3=9 images are printed on one page. Meanwhile, the thumbnail in FIG. 7 is also displayed in an arrangement of 3×3 corresponding to the arrangement of the images. The number of the images printed in the length and breadth of one page is obtained by dividing the size of the sheet by the size of one print image, in a vertical direction and in a crosswise direction respectively. Note that a blank space to be secured in a peripheral part of the sheet and between images is estimated in calculation. The number of pages required for printing is calculated as follows. For example, when the user wishes to print 45 images, there are nine images per one page, and therefore the required number of pages is obtained by 45÷9=5 (pages). This calculation result is displayed in the “required number of pages”.

Here, when the user selects the candidate 2 (B4 size), 3×2=6 images are to be printed on one page. When the candidate 2 is selected, the thumbnail in FIG. 7 is updated to the arrangement of 3×2 and is displayed. As described above, the number of the images in the length and breadth of one page is recalculated by dividing the selected sheet size by the size of the image. When there are 45 images desired to be printed and there are 6 images per one page, the required number of pages is obtained by 45÷6=8 (pages). The number of pages is obtained by rounding up a decimal point. This calculation result is displayed in the “required number of pages”.

### Embodiment 4

In this embodiment, description is given to a mode in which the displayed thumbnail is set so that the user can perform operation of moving it on the screen and the CPU 21 adjusts a position of the image printed on the sheet according to the operation.

FIG. 10 is an explanatory view showing an example of a screen for image positional adjustment according to this embodiment. The user can adjust the position of the image printed on the sheet by using the screen of FIG. 10. The screen of FIG. 10 may be displayed after the user selects the “OK” button in the screen of FIG. 7. Alternately, an “image positional adjustment” button is arranged in the screen of FIG. 7 (not shown in FIG. 7), and when the user selects the “image positional adjustment” button, the screen of FIG. 1 may be displayed.

A thumbnail display area 31 is arranged in an about half area of the left side of the screen in FIG. 10. The thumbnail display area 31 corresponds to one page of the print sheet. In addition, each button of four arrow buttons 33a, 33b, 33c, 33d, an initialization button 35 arranged at a position surrounded by the arrow buttons, and a range designation mode button 37 are arranged in the screen of FIG. 10. These buttons are arranged for adjusting the position of the printed image. Further, there are arranged movement width input sections 39a, 39b for inputting a step width of a movement by a numerical value by using the arrow buttons. Then, “OK” and “Cancel” buttons are arranged.

The CPU 21 decides a size and an arrangement position of each thumbnail in the thumbnail display area 31 according to a finish state of printing. In the example of FIG. 10, seven thumbnails are displayed in the vertically long thumbnail display area 31. Seven thumbnails are aligned to be three rows in the vertical direction and three rows in the crosswise direction. Each thumbnail of the row of the left end is arranged closer to a center compared to each thumbnail of the row of the right end. This shows a “binding margin” is provided on the left end of the sheet. The CPU 21 decides an interval from a frame of the thumbnail display area 31 to the end of the thumbnail, according to the blank space and the binding margin that can be set by the user. In addition, the CPU 21 decides the interval between images on the sheet, from the number of images aligned lengthwise and breadthwise and a dimension of the sheet excepting the binding space. In an initial state in which no adjustment is performed by the user, each image is arranged in the vertical direction and in the crosswise direction at an equal interval. After the interval between images on the sheet is calculated, the CPU 21 decides the interval between thumbnails displayed on the screen according to the aforementioned interval between images. Thus, the thumbnail is displayed in the thumbnail display area 31. The user can adjust the thumbnail displayed in the thumbnail display area 31.

When the user locates a cursor on one thumbnail and clicks this thumbnail, the thumbnail thus clicked is selected as an object to be adjusted. FIG. 10 shows a state in which one thumbnail located in the row of the center in both vertical and crosswise directions is selected. A frame line F is displayed around the selected thumbnail. Here, selection of the thumbnail may be canceled when the user clicks an already selected thumbnail. Also, when the user clicks the range designation mode button 37, the range designation mode becomes effective. When the user clicks the range designation mode button 37 when the mode is set in the range designation mode, the range designation mode is canceled. Alternately, when the user drags the cursor in the thumbnail display area 31 when the mode is set in the range designation mode, a rectangular area, with a line connecting a start point and an end point of drag operation set as a diagonal line, is displayed, and the thumbnail included in the displayed rectangular area is selected as an adjustment object. The user can select a plurality of thumbnails by performing drag operation in the range designation mode.

When the user clicks any one of the four arrow buttons, the thumbnail of the adjustment object moves by a prescribed width in a direction shown by the clicked arrow. A distance the thumbnail moves is previously defined as 2 mm, for example, as a distance the image moves in a state of the print sheet. A movement distance of the thumbnail on the screen is determined based on the finish of the print and a pitch of a display pixel. Every time the user clicks the arrow button, the thumbnail moves by a prescribed distance in a direction of the clicked arrow button. The CPU 21 executes the processing so as to realize the aforementioned function according to the operation by the user. The position of the image that can be printed on the sheet is determined based on the aforementioned operation.

The movement width of the image by clicking the arrow button is changed from a default of the movement width when the user inputs a numerical value in the movement width input sections 39a and/or 39b. Input of the numerical value is performed by the user using the keyboard, for example. For example, after inputting “5” by the user in the movement width input section 39a (input column of the movement width in the crosswise direction (X direction)), the arrow button 33d is clicked. In this case, the CPU 21 calculates the position obtained by shifting the print position of the image on the sheet to the right side by 5 mm. Further, the CPU 21 calculates the display position of the thumbnail according to a calculation result, and updates the screen display according to the calculation result of the display position. Thus, the selected thumbnail moves in a right direction.

When the initialization button 35 is clicked, under the control of the CPU 21, the position of each thumbnail is returned to an initial state. Alternately, since the history is stored in adjustment, under the control of the CPU 21, the thumbnail may be returned by tracing the adjustment step by step, every time the initialization button 35 is clicked. Not only the screen display, but also the initialization position of the image printed on the sheet is returned to the initialization position or the position obtained by tracing the adjustment.

When it is found that the image is to be moved to an unprintable position as a result of calculating the print position of the image, the CPU 21 may prohibit the image from moving to the unprintable position. Also, as a result of calculating the print position of the image, when it is found that the image is moved to the position where the image is overlapped with other image, the CPU 21 may prohibit the image from moving to the position where the image is overlapped with other image. Specifically, it is assumed that the user selects the thumbnail at the left end and performs the operation of moving the selected thumbnail to the left side by clicking the arrow button 33a. According to this operation, the CPU 21 calculates the print position of the image on the sheet. When it is so judged that the position of the left end of the image thus calculated is in a region to be secured as the binding margin, the CPU 21 may align the left end of the image to an end of a print possible region. Namely, when the image is protruded from the print possible region, movement of the image may be clipped. In accordance thereto, the position of the thumbnail displayed on the screen is also clipped. Further, the CPU 21 may let the user notified of the matter that the movement of the image is clipped, by means of sound, illustration, or message. In addition, when the numerical value is inputted in the movement width input section 39a or the 39b, the CPU 21 may delete the inputted numerical value, for re-inputting a further smaller numerical value. Moreover, display such as urging the re-input of the numerical value in the movement width input section 39a or 39b, such as display of blinking the cursor may be performed.

After the user performs the operation as described above, when the user clicks the “OK” button on the screen, the position of the image according to the operation is determined, and the CPU 21 starts the print processing. At this time, the print position of the image printed on the sheet is based on an adjustment result of the user. Meanwhile, when the user pressed the “cancel” button on the screen, the adjustment performed by the user on the screen 10 becomes ineffective.

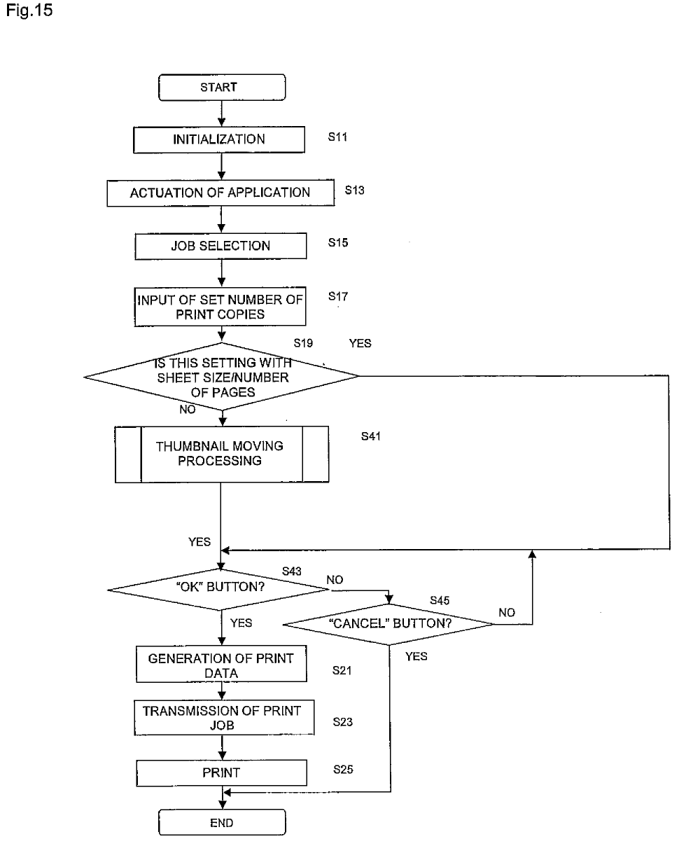

FIG. 15 is a flowchart showing a processing procedure of the CPU 21 according to this embodiment. The same signs and numerals are assigned to the step corresponding to FIG. 13. Steps S41, S43, S45 are different points from FIG. 13. Namely, in Step S19, the screen of FIG. 3 is displayed and when the user selects the “No” button, the CPU 21 displays the screen of FIG. 10. In the screen of FIG. 10, the user performs adjustment so as to move the position of the image (Step S41), and when the user selects the “OK” button (Step S43), the CPU 21 starts a generation of the print data under the determined condition (Step S21). Meanwhile, when the user selects the “Cancel” button on the screen of FIG. 10 (Step S45), the print processing is canceled.

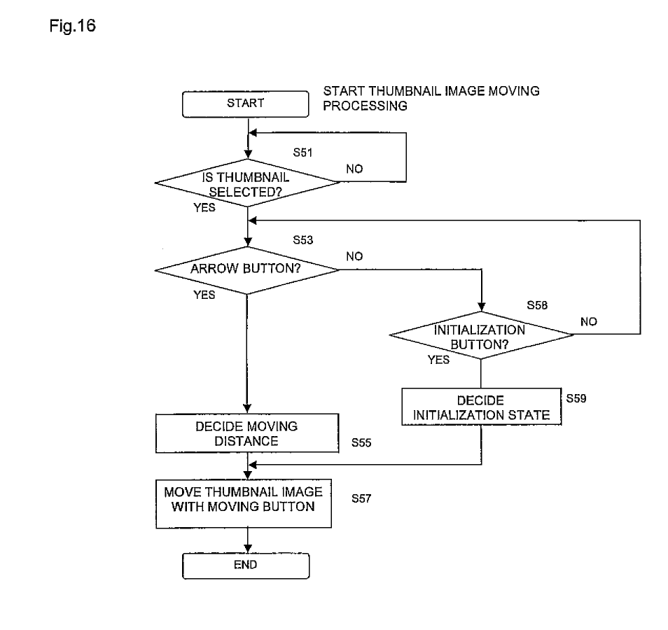

Details of the aforementioned processing in Step S41 is shown in FIG. 16. First, after the screen of FIG. 10 is displayed, the CPU 21 waits for the selection of a thumbnail image by the user (Step S51). When the thumbnail image is selected, next, the instruction to move the selected thumbnail is awaited (Step S53). Here, when any one of the four arrow buttons is selected, the CPU 21 performs a position calculation for moving the selected thumbnail in a direction shown by the arrow buttons (Step S55). The position calculation is performed for obtaining the print position where the image is printed on the sheet. Thereafter, the display position of the thumbnail corresponding to the print position is obtained. Then, the screen is updated to display the thumbnail at the obtained display position (Step S57). When the numerical value is inputted in the movement width input section 39a and/or 39b, the CPU 21 obtains the print position and the display position by using the inputted numerical value. When the numerical value is not inputted in the movement width input section 39a and/or 39b, the print position and the display position are obtained by using a previously defined movement width.

When the arrow button is not selected in Step S53, routine is advanced to Step S58 to check whether or not the initialization button 35 is selected. When the initialization button 35 is selected, the print position of each image and the display position of each thumbnail in the initial state are calculated (Step S59). Thereafter, the routine is advanced to Step S57, and based on the calculation result, the display of the image is updated.

### Embodiment 5

In this embodiment, description is given to a mode in which the user operates the displayed thumbnail so that the magnification ratio of each image can be designated on the screen, and the CPU 21 adjusts the magnification ratio of each image to be printed according to the operation.

In addition to the positional adjustment of the image described in Embodiment 4, the size of each image can be made adjustable individually. The screen of FIG. 10 shows an example of an operation method to enable such an adjustment, wherein further “magnification adjustment” button (not shown in FIG. 10) is added. When the “magnification adjustment” button is clicked, the CPU 21 displays the screen of FIG. 11 in the display section. FIG. 11 shows an example of a magnification ratio setting screen for individually adjusting the magnification ratio of each image to print the image on the sheet. As shown in FIG. 10, the user selects the thumbnail for adjusting the magnification ratio on the screen, and clicks the aforementioned “magnification adjustment” button (not shown). In response to this operation, the CPU 21 displays the screen of FIG. 11. In the screen shown in FIG. 11, the user can select and set frequently used six magnification ratios by one action. The six magnification ratios are 20%, 40%, 60%, 80%, 100%, and 120%. In the screen of FIG. 11, a radio button is disposed at the left side of each magnification ratio, and when the user clicks any one of radio buttons, the magnification ratio corresponding to the radio button is applied to the thumbnail and the image corresponding thereto. When the magnification ratio other than the six magnification ratios is set, the numerical value is directly inputted in the column at the right side of “Others”, and the radio button at the left side of the “Others” is clicked.

When the user sets the magnification ratio on the screen of FIG. 11 and presses the “OK” button, the CPU 21 calculates again the print size of the image and the display size of the thumbnail according to the magnification ratio set in response to pressing of the “OK” button. In addition, a screen 11 disappears to return to a screen 10. At this time, the thumbnail displayed in the screen 10 is updated to the size according to the magnification ratio set by the user in the screen 11. In this state, when the user presses the “magnification adjustment” button again, the CPU 21 displays the screen 11 again to enable reset of the magnification ratio. Meanwhile, when the user presses the “OK” button in the screen 10, the set magnification ratio is determined, and the CPU 21 starts the print processing. At this time, the image printed on the sheet is based on the set magnification ratio.

### Embodiment 6

In this embodiment, description is given to a mode capable of reducing the number of images on one page calculated by the CPU 21, according to the operation by the user.

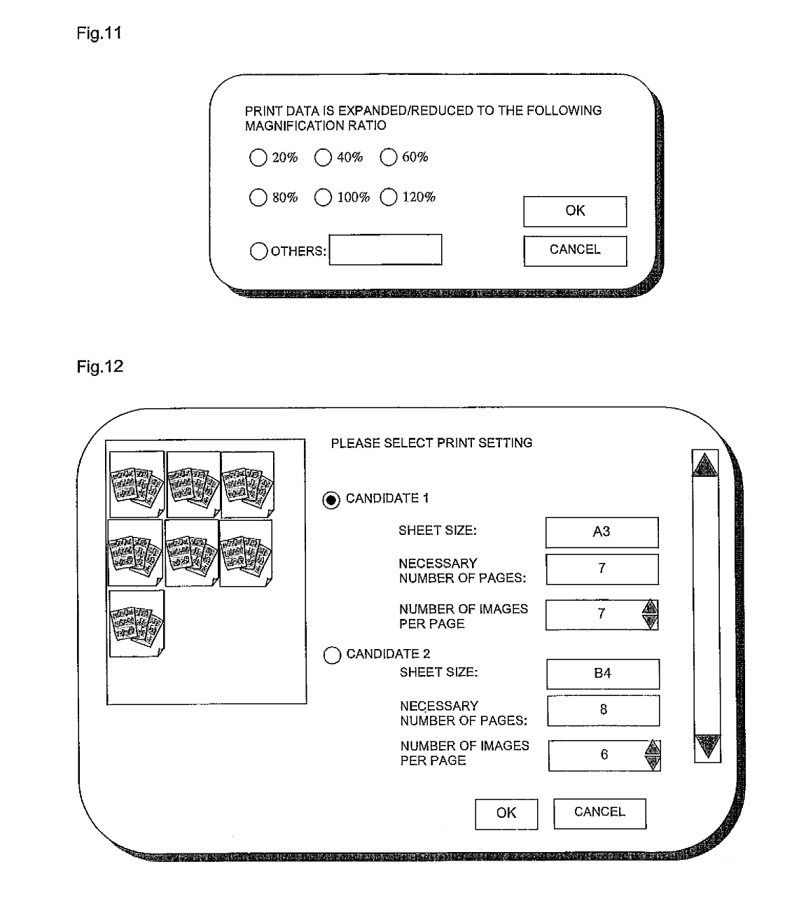

FIG. 12 is an explanatory view showing an example of a screen for allowing the user to adjust the number of images per one page of the sheet derived by the CPU 21. The screen of FIG. 12 corresponds to the screen of FIG. 7. A different point between the screen of FIG. 12 and the screen of FIG. 7 is that the column for setting “the number of images on one page” is provided, and the numerical value of this column can be adjusted in the screen of FIG. 12. For example, in FIG. 12, “7” is displayed as the number of images per one page of “Candidate 1”. However, this shows a state after adjustment, and in the initial state, the number of images per one page is “9”. When the user changes the numerical value of “the number of images per one page”, the CPU 21 calculates again the print condition according to the change of the numerical value. In a case of FIG. 12, “7” is displayed in the column of the “necessary number of pages”. In the initial state, this numerical value is “5”. Along with a change operation of the number of images, the print condition is updated and the numerical value of the “necessary number of pages” is changed from “5” to “7”.

When the user presses the “OK” button on the screen shown in FIG. 12, seven images are printed on one page of the sheet. The number of pages of the sheet required for print is seven pages. Note that the CPU 21 may control so that determined setting is stored as a history and preferentially displayed as the next candidate.

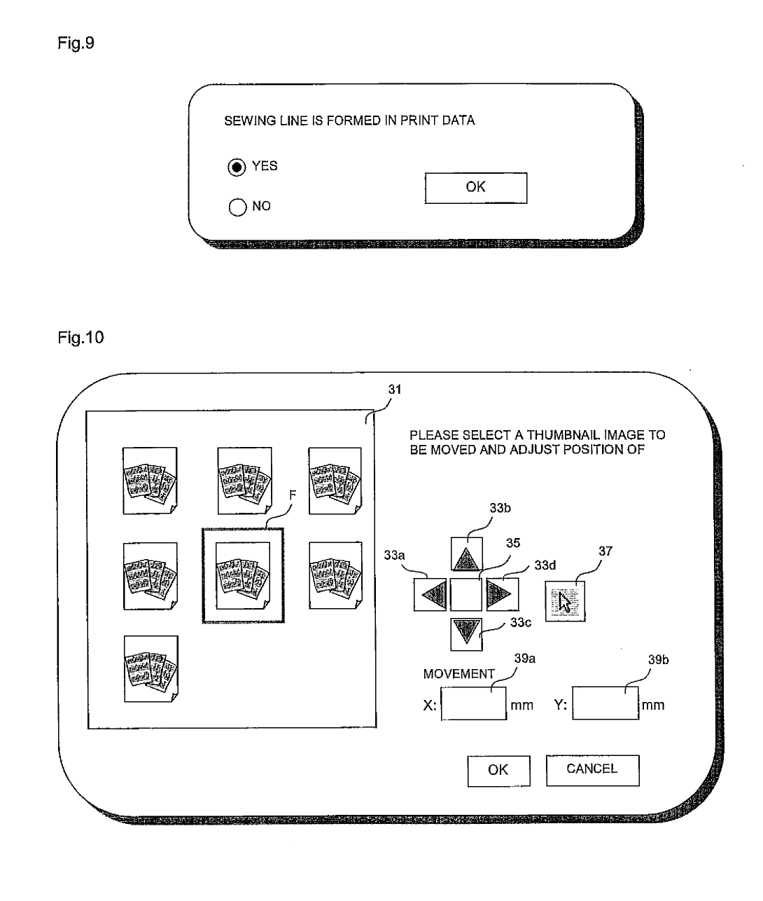

Further, as a modified example of the aforementioned embodiments, print may be performed, with a boundary line drawn around the image printed. When the user cuts and divides the printed image, a line to be cut-off is given by the boundary line. Specifically, for example, the CPU 21 displays the screen shown in FIG. 9 after the candidate is determined. By using the screen, whether or not print the boundary line (sewing line) for cutting-off the image is selected by the user.

Finally, it is apparent that there can be various modified examples for this invention. Such modified examples should not be interpreted as not belonging to the characteristics and range of this invention. The range of the present invention includes all modifications within the scope of the claims and within the scope of the meaning equivalent to the claims.

What is claimed is:

1. A print processing apparatus for sending image data to a printer having a sheet storage section for storing a sheet and a printing section for printing on the sheet the image data received from an outside apparatus, the print processing apparatus comprising:
a setting section of print copies for allowing a user to set the number of the print copies;
a deriving section for deriving a size of the sheet to contain at least one page of the image data, the number of pages to be contained in the sheet, and the number of sheets required for printing, based on a size of the sheet stored in the sheet storage section, on a size of each page of the image data, and on the set number of the print copies;
a display section for displaying derived results as a candidate of a print condition; and
a determination section for allowing the user to determine the displayed candidate.

2. The print processing apparatus according to claim 1, wherein when there are a plurality of candidates, the display section displays the candidates entirely or partially, and the determination section allows the user to select one of the candidates.

3. The print processing apparatus according to claim 2, further comprising:
a display control section for controlling to display each of the candidates selectable by using a scroll bar when the display section has a width for displaying only a part of the candidates.

4. The print processing apparatus according to claim 1, further comprising:
a thumbnail generation section for generating a thumbnail of an image included in the image data; and
a display control section for controlling to display thumbnails according to the number of images to be contained in the sheet.

5. The print processing apparatus according to claim 4, wherein when a plurality of images are to be contained in the sheet, the deriving section further derives an arrangement of each of the images, and the display control section displays the thumbnails according to the number of the images to be contained in the sheet and the arrangement thereof.

6. The print processing apparatus according to claim 1, further comprising:
a history storage section for storing a determined print condition as a history; and
a display control section for determining the candidate to be displayed according to the history.

7. The print processing apparatus according to claim 1, wherein when a plurality of images are contained in the sheet, the printing section prints each of the images with boundary lines.

8. The print processing apparatus according to claim 4, further comprising:
a thumbnail movement control section for controlling the displayed thumbnails to be moved by the user on the display section; and
a print position control section for controlling a print position so that each of the images is printed at the position on the sheet corresponding to a display position of each of the thumbnails.

9. The print processing apparatus according to claim 5, further comprising:
a thumbnail size control section for controlling sizes of the displayed thumbnails to be expanded and reduced by the user on the display section; and
a control section of a print magnification ratio for controlling the print magnification ratio so that each of the images is printed on the sheet with the print magnification ratio corresponding to the sizes of the displayed thumbnails.

10. The print processing apparatus according to claim 5, further comprising:
an instruction section of the number of images for controlling the number of the images contained in the sheet to be changed by the user.
